(19) United States
(12) Patent Application Publication
(10) Pub. No.: US 2017/0048511 A1
(43) Pub. Date: Feb. 16, 2017

(54) Method for Stereoscopic Reconstruction of Three Dimensional Images

(71) Applicant: INUITIVE LTD., Ra'anana (IL)

(72) Inventor: Ziv TSOREF, Tel Aviv (IL)

(21) Appl. No.: 15/306,193

(22) PCT Filed: May 21, 2015
(86) PCT No.: PCT/IL2015/000028

§ 371 Date: Oct. 24, 2016

Related U.S. Application Data
(60) Provisional application No. 62/004,192, filed on May 28, 2014.

(51) Int. Cl. H04N 13/02; G06T 1/00; H04N 5/33; G06T 7/00

(52) U.S. Cl. CPC H04N 13/0239; G06T 7/0075; G06T 1/0007; H04N 13/0253; H04N 5/33; H04N 2013/0081

(57) ABSTRACT

A method and apparatus are provided for generating a three dimensional image. The method comprises the steps of: determining deviations that exist between at least two image capturing devices, each configured to capture essentially the same image as the other (s); determining a correction function to enable correcting locations of pixels belonging to each stream of pixels to their true locations within an undistorted image; retrieving two or more streams of pixels, associated with an image captured by a respective image captured device; applying the correction function onto received pixels; applying a stereo matching algorithm for processing data; and generating a three-dimensional image based on the results obtained from the stereo matching algorithm.

### TECHNICAL FIELD

The present disclosure generally relates to methods for using optical devices, and more particularly, to methods that enable stereoscopic reconstruction of three dimensional images.

### BACKGROUND

A stereoscopic camera arrangement is an element made of two camera units, assembled in a stereoscopic module. Stereoscopy (also referred to as “stereoscopics” or “3D imaging”) is a technique for creating or enhancing the illusion of depth in an image by means of stereopsis. In other words, it is the impression of depth that is perceived when a scene is viewed with both eyes by someone with normal binocular vision which is responsible for creating two slightly different images of the scene in the two eyes due to the eyes'/camera's different locations.

Combining 3D information derived from stereoscopic images, and particularly for video streams, requires search and comparison of a large number of pixels to be held for each pair of images where each derived from a different image capturing device. For example, in the case of a 2 MP sensor operating at 60 fps and generating 16 bpp (bits per pixel), the bit rate would be a 4MB per frame or over 240 MB per second. This amount of information makes it virtually impossible (in particularly for consumer products such as laptops and tablets) to have the information processed or even stored for a short while, as to do so would require resources that are usually unavailable in consumer products.

Therefore, in order to incorporate such capabilities within low cost consumer platformsn such as PC's, laptops, tablets and the like, while at the same time ensuring high accuracy and high frame rate (low latency) in generating 3D images based on information derived from two or more sources, a new approach should be adopted. One that overcomes the problems associated with the related memory and CPU requirements that exceed by far the available capabilities in such consumer devices.

Typically, the currently known devices address this issue in one of the following ways:
1. By lowering the pixel resolution (input of VGA or lower);
2. By lowering the frame rate (e.g. to a 15 frames per second rate or lower); or
3. By narrowing the field of view (FOV) to practically eliminate distortion and misalignment problems.

In addition, there are other options to address this matter. For example, by replacing the stereo matching technology with another available technology, such as Structured Light or Time of Flight. However, as any person skilled in the art would appreciate, these technologies have their own limitations, such as a high cost, high power requirements, etc. Therefore, they do not provide an adequate solution to the problem as the overall cost of a 3D image reconstruction system based on these technologies is considerably higher, on a per pixel basis, than of a system which is based on stereoscopic technology.

A number of solutions were proposed in the art to overcome the problems associated with the alignment of stereoscopic arrangements. For example:

US 20120127171 describes a computer-implemented method which comprises performing stereo matching on a pair of images; rectifying the image pair so that epipolar lines become one of horizontal or vertical; applying stereo matching to the rectified image pair; generating a translated pixel from a root pixel, wherein the generating comprises applying a homography matrix transform to the root pixel; and triangulating correspondence points to generate a three- dimensional scene.

US 20090128621 describes a system that provides an automated stereoscopic alignment of images. The system provides automated stereoscopic alignment of images, such as, for example, two or more video streams, by having a computer that is programmed to automatically align the images in a post production process after the images are captured by a camera array.

### SUMMARY OF THE DISCLOSURE

The disclosure may be summarized by referring to the appended claims.

It is an object of the present disclosure to provide a new method for providing a high accuracy 3D reconstruction of images using high resolution and high frame rate sensors, and low latency, i.e., the time that passes from the moment at which the image was captured to the time at which the reconstruction of the 3D image is completed, while still maintaining relatively low the processing and memory requirements associated with the computational system.

It is yet another object of the present disclosure to provide a method and an apparatus for retrieving information from image capturing devices operating within different wavelength ranges, for reconstructing 3D images.

Other objects of the present invention will become apparent from the following description.

According to one embodiment of the disclosure, there is provided a method for generating a three dimensional image which comprises the steps of:
determining spatial deviations that exist between images captured by at least two image capturing devices, each configured to capture essentially the same image as the at least one other image capturing device;
for pixels associated with an image that will be taken by each of the at least two image capturing device, determining a correction function to enable correcting locations of pixels belonging to each stream of pixels to their true locations within an undistorted image derived based on an image that will be taken by a respective image capturing device;
retrieving two or more streams of pixels, each associated with an image captured by a respective one of the at least two image capturing devices;
applying the respective correction function onto received pixels of the two or more streams of pixels;
storing data associated with pixels of the two or more streams of pixels in a memory means, wherein the memory means is capable of storing data associated with only a substantially reduced amount of pixels from among the pixels that belong to the two or more streams of pixels associated with the captured image;
applying a stereo matching algorithm for processing data retrieved from the memory means; and
generating a three-dimensional image based on the results obtained from the stereo matching algorithm.

According to another embodiment, the memory means is capable of storing information associated with only from about 5% to about 25% of the amount of pixels that belong to each of the two or more streams of pixels associated with the captured image.

By yet another embodiment, the memory means is capable of storing information associated with only 10% or less of the number of pixels that belong to each of the two or more streams of pixels associated with the captured image.

In accordance with still another embodiment, the method provided further comprises a step of illuminating a target (e.g. by visible light, NIR radiation, etc.) whose image is to be captured by the at least two image capturing devices, at a time when the image is being captured. In case this embodiment is implemented, when applying the algorithm on the retrieved information, the method provided preferably further comprises a step of selecting whether to rely mainly on information that was retrieved from the visible light image capturing device or from the IR image capturing device or from a combination thereof. Thus, the results that will be obtained from using the stereo matching algorithm will be of higher accuracy and will allow generating a better three dimensional image.

According to another embodiment, at least one of the two or more streams of pixels, is a stream of pixels captured by an image capturing means operative in the near Infra-Red (“NIR”) wavelength range.

By still another embodiment, the method further comprising a step of associating a different weight to pixels being processed by the stereo matching algorithm, based on illumination conditions that existed at a place and time of capturing the image with which the pixels are associated. For example, when operating under dark settings, mostly the near IR data will be used, whereas when operating under bright settings, mostly information retrieved from the image capturing device operating at the visible wavelength, will be used.

In accordance with another embodiment, the method provided further comprises a step of generating a three-dimensional video stream from multiple groups of images (frames), where the images that belong to any specific group of images, are images that were captured essentially simultaneously.

By still another embodiment, when a three-dimensional video stream is generated, the method further comprises a step of carrying out a matching process between images that belong to a current group of images by relying on information derived from images that belong to a group of images that were captured prior to the time at which the current group of images was captured.

The term “stereoscopic” (or “stereo”) as used herein throughout the specification and claims, is used typically to denote a combination derived from two or more images, each taken by a different image capturing means, which are combined to give the perception of three dimensional depth. However, it should be understood that the scope of the present invention is not restricted to deriving a stereoscopic image from two sources, but also encompasses generating an image derived from three or more image capturing means.

The terms “image” and “image capturing device” as used herein throughout the specification and claims, are used to denote a visual perception being depicted or recorded by an artifact (a device), including but not limited to, a two dimensional picture, a video stream, a frame belonging to a video stream, and the like.

The correction function described and claimed herein, is mentioned as being operative for pixels associated with an image that will be taken by each of the at least two image capturing device. As will be appreciated by those skilled in the art, the correction function is preferably determined for various pixels prior to taking the actual images from which the three dimensional images will be generated, and therefore should be understood to relate to correcting the location of individual pixels within an image that will be captured by an image capturing device, into a corrected undistorted image derived from the actually captured image. Thus, it should be understood that the term “pixels” when mentioned in relation with the correction function, relates to the respective pixels' locations and not to the information contained in these pixels.

According to another aspect of the disclosure, there is provided an electronic apparatus for generating a three dimensional image that comprises:

at least two capturing devices configured to focus on a target and to capture essentially simultaneously images thereof;

one or more processors configured to:
calculate or be provided with information on spatial deviations that exist between the at least two image capturing devices to determine therefrom a correction function operative to correct location of pixels that belong to the images, so as to receive their true location at an undistorted image derived from an image that will be taken by the respective image capturing device;
retrieve two or more streams of pixels, each associated with an image captured by a respective one of the at least two image capturing devices;
apply the respective correction function onto received pixels from among the two or more streams of pixels;
store data associated with pixels of the two or more streams of pixels in a memory means;
invoke a stereo matching algorithm for processing data retrieved from the memory means; and
generate a three-dimensional image based on the results obtained from the stereo matching algorithm; and

a memory means adapted to store data associated with only a substantially reduced amount of pixels from among the pixels that belong to the two or more streams of pixels associated with the captured images.

According to another embodiment, the memory means is capable of storing data associated with only from about 5% to about 25% of the amount of pixels that belong to each of the two or more streams of pixels associated with the captured image.

By yet another embodiment, the memory is capable of storing data associated with only 10% or less of the amount of pixels that belong to each of the two or more streams of pixels associated with the captured image.

In accordance with still another embodiment, the electronic apparatus further comprises an illuminator configured to illuminate a target (e.g. by visible light and/or by NIR radiation) whose images are captured by the at least two image capturing devices, at a time when the images are being captured. Typically, there are two types of illuminators that may be used. The first being an illuminator that throws ‘flood’ light, thereby improving visibility of the target, whereas the other type is configured to provide a textured light, such as light in a pre-defined pattern, thereby generating more information that may be applied during processing by the stereo matching algorithm, the data retrieved, which in turn might lead to having a more accurate matching between the two images being matched.

By still another embodiment, at least one of the image capturing devices is operative at the near Infra-Red (“NIR”) wavelength range.

According to another embodiment the processor is operative to generate a three-dimensional video stream from multiple groups of images (frames), where the images that belong to any one of groups of images, are images that were captured essentially simultaneously.

By still another embodiment, when a three-dimensional video stream is generated, the processor is further operative to carry out a matching process between images that belong to a current group of images, by relying on information derived from images that belong to a group of images that were captured prior to the time at which the current group of images was captured.

### BRIEF DESCRIPTION OF THE DRAWING

For a more complete understanding of the present invention, reference is now made to the following detailed description taken in conjunction with the accompanying drawings wherein:

FIG. 1—is a flow chart illustrating a method for carrying out an embodiment of the present invention; and

FIG. 2—is a flow chart illustrating a method for carrying out another embodiment of the present invention.

### DETAILED DESCRIPTION

In this disclosure, the term “comprising” is intended to have an open-ended meaning so that when a first element is stated as comprising a second element, the first element may also include one or more other elements that are not necessarily identified or described herein, or recited in the claims.

Also, in the following description, for the purposes of explanation, numerous specific details are set forth in order to provide a better understanding of the present invention by way of examples. It should be apparent, however, that the present invention may be practiced without these specific details.

Typically, a stereo matching algorithm is an algorithm operative to match pairs of pixels, where each member of such a pair of pixels is derived from another image, and the two images are obtained from two different image capturing devices that are both focused at the same point in space as the other. According to prior art methods, once all the pixels in one image are correctly matched with pixels that belong to the other image, calculation of the distance of an object seen in each pixel, becomes a practically straightforward and simple process. Obviously, the major drawback of this method is that the process of matching the pixels entails carrying out a cumbersome process of comparing all the pixels that belong to one image with those that belong to the other image.

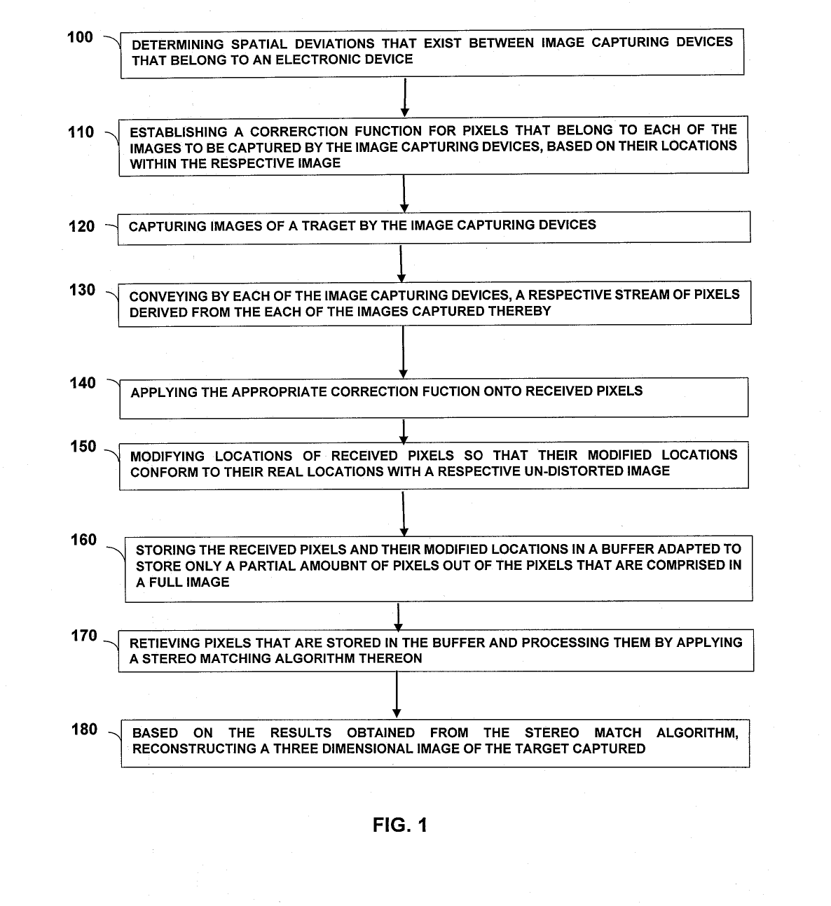

FIG. 1 provides a flow chart which is exemplifies one embodiment of a method for carrying out the present invention, in order to generate a three dimensional video stream that comprises a plurality of three dimensional frames.

First, an electronic apparatus comprising two sensors operative as image capturing devices (e.g. cameras) that are configured to operate in accordance with an embodiment of the present disclosure, is calibrated. The calibration is carried out preferably in order to determine spatial deviations that exist between these image capturing devices, thereby to enable establishing what would be the distortion between each pair of images (e.g. frames) that will be taken in the future, where both image capturing devices are configured to capture essentially the same image and at essentially the same time (step 100).

Next, based on the spatial deviations determined between the two image capturing devices in step 100, a correction function is determined for pixels associated with each of the images to be captured by the image capturing devices, based on the pixels' locations within the respective image. This correction function will then be used to correct locations of pixels that will be retrieved from their respective image capturing device, thereby when they are processed, the processing will comprise modifying the pixels' locations as received from the image capturing devices, to their true location within the image (after eliminating the distortions that exist between the two images), once that image is taken by its respective image capturing device (step 110). In addition, this calibrating step may be used to determine the number of pixels' rows that need to be buffered as will be further explained, in order for the algorithm that will be used to process this data, to receive the appropriate inputs while ensuring that no significant gaps of missing pixels are formed.

Then, the sensors operative as image capturing devices (e.g. cameras), are focused at a target and capture images thereof (step 120), wherein each of the image capturing devices conveys a respective stream of pixels derived from the image (frame) captured by that image capturing device (step 130).

The pixels that belong to each of the streams of pixels arriving at the processor of the electronic device, do not arrive according to an orderly manner, since the image as was captured by each of the image capturing devices, is in a distorted form (step 140).

The locations of the pixels of the arriving streams are modified by applying thereon the appropriate correction function, thereby enabling to ensure that their modified locations conform with their true locations within a respective un-distorted image (step 150). The received pixels and their modified locations are then stored in a buffer for processing. The buffer is adapted to store only a partial amount of pixels for each of the images captured by the image capturing devices, out of the full amount of pixels comprised in each of the respective full images (step 160). The buffer (memory means) is characterized in that it is capable of storing only a substantially reduced number of pixels from among the pixels that belong to the streams of pixels associated with the captured image. For example, about 10% of the total number of pixels that belong to each stream of pixels. This characteristic has of course a very substantial impact upon the costs associated with the electronic device (since only about 10% of the storage capacity would be required, and similarly the processing costs for applying the stereo matching algorithm on the stored pixels, will also be reduced).

A stereo matching algorithm is then applied for processing the buffered information associated with the pixels that belong to each of the two or more streams of pixels (step 170). The data that may be processed at any given time (associated with the buffered pixels), is substantially less than the data associated with all the pixels that belong to each respective stream of pixels. Furthermore, it should be noted that by following this embodiment of the invention, is becomes possible to estimate the anticipated arrival time of a certain, currently missing pixel based on information obtained from the calibration step as explained above.

Based on the results obtained from the stereo matching algorithm, a three-dimensional image is then generated (step 170).

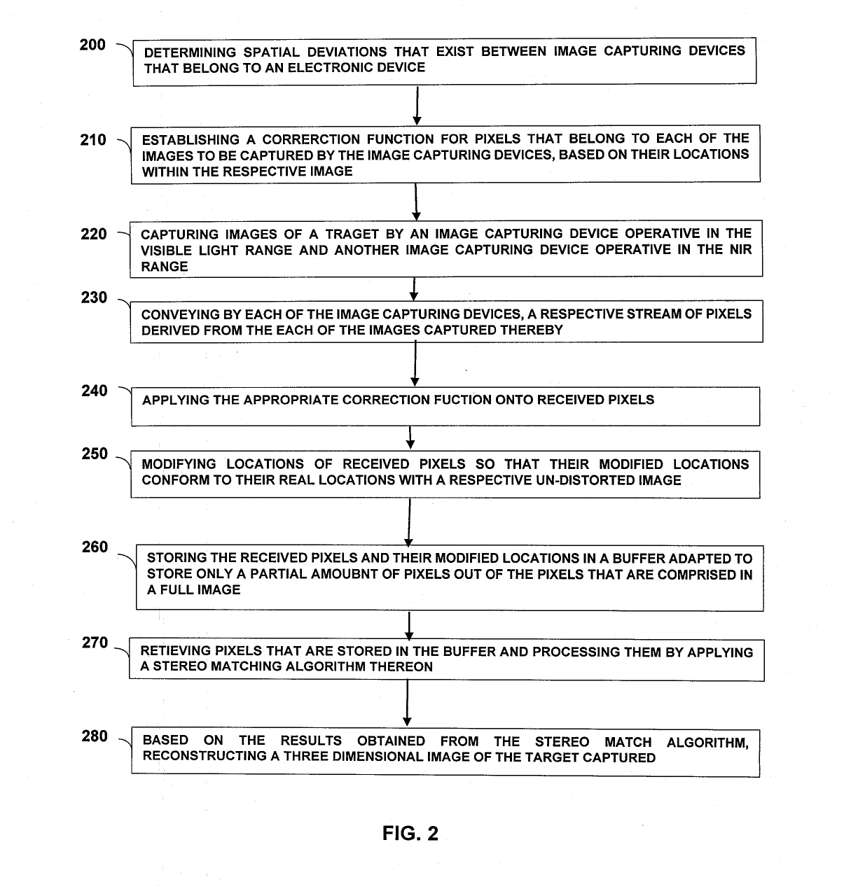

FIG. 2 illustrates a flow chart of a method that is carried out in accordance with another embodiment of the present disclosure.

Steps 200 and 210 are carried out similarly to steps 100 and 110 of the example illustrated in FIG. 1. In this example, the two sensors operating as image capturing devices (e.g. cameras) are low cost and standard sensors, preferably having the NIR filter removed from at least one of them. Consequently, one of the two image capturing devices (of the two sensors) would be operative to capture consecutive frames of the target by using visible light photo sensitive receptors, whereas the second of the two image capturing devices (the sensor from which the NIR filter was removed) would be operative to capture video frames both in the near infra red range of the electromagnetic spectrum (a range that extends from about out 800 nm to 2500 nm) and in the visible light (step 220). Moreover, the apparatus may optionally further comprise illuminating means such as a standard LED based IR illuminator (without requiring laser devices or any other high cost, high power, illuminating devices), configured to illuminate the target with radiation in the IR (or NIR) range in order to get better results when capturing the NIR video frames.

Two streams of pixels are then retrieved from the two image capturing devices (step 230) at both wavelength ranges by one or more processors, thereby obtaining data associated with the captured frames (images) in order to generate the three dimensional video stream therefrom.

For the sake of this example, we shall assume that under normal operating conditions, most of the information relevant to a certain frame is static (e.g. foreground/background), therefore for the most part the frame, the changes occurring between two consecutive frames are relatively small. This assumption is helpful in significantly reducing the search regions while generating each three dimensional frame, by constructing low accuracy 3D data and then having the accuracy improved from one frame to the next.

Once each of the streams of pixels arrives to the processor of the electronic device, the appropriate correction function is applied onto received pixels (from among the arriving streams of pixels) (step 240).

The locations of the pixels of the arriving streams are then modified so as their locations will conform with their real locations within a respective un-distorted image (step 250) and then they are stored in a buffer (step 260).

A stereo matching algorithm is then applied for processing only pixels retrieved from the buffer(s) associated with each of the two or more streams of pixels (step 270), while taking into account parameters such as the wavelength at which the image (that led to generating one of the pixels' streams) was captured, the illumination conditions at the time and place when the image was captured, etc., in order to determine the weight that may be given to the information received at each of the different wavelengths, in order to ultimately improve the resulting three dimensional images.

Based on the results obtained from the stereo matching algorithm, a three-dimensional image is generated (step 280).

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention in any way. For example, the apparatus may include a cameras' array that has two or more cameras, such as, for example, video cameras to capture two or more video streams of the target. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A method for generating a three dimensional image, comprising the steps of:
determining deviations that exist between at least two image capturing devices, each configured to capture essentially the same image as the at least one other image capturing device;
for pixels associated with an image that will be taken by each of the at least two image capturing device, determining a correction function to enable correcting locations of pixels belonging to each stream of pixels to their true locations within an undistorted image derived based on an image that will be taken by a respective image capturing device;
retrieving two or more streams of pixels, each associated with an image captured by a respective one of the at least two image capturing devices;
applying the respective correction function onto received pixels from among the two or more streams of pixels;
storing data associated with pixels that belong to the two or more streams of pixels in a memory means, wherein said memory means is capable of storing data associated with only a substantially reduced number of pixels from among the pixels that belong to the two or more streams of pixels associated with the captured image;
applying a stereo matching algorithm for processing data retrieved from said memory means; and
generating a three-dimensional image based on the results obtained from the stereo matching algorithm.

2. The method of claim 1, wherein said memory means is capable of storing data associated with only from about 5% to about 25% of the number of pixels that belong to each of the two or more streams of pixels associated with the captured image.

3. The method of claim 2, wherein said memory means is capable of storing data associated with only 10% or less of the amount of pixels that belong to each of the two or more streams of pixels associated with the captured image.

4. The method of claim 1, further comprising a step of illuminating a target whose image is to be captured by the at least two image capturing devices, at a time when said image is being captured.

5. The method of claim 1, wherein said at least one of the two or more streams of pixels, is a stream of pixels captured by an image capturing means operative at the near Infra-Red (“NIR”) wavelength range.

6. The method of claim 5, further comprising a step of associating a different weight to data associated with pixels being processed by the stereo matching algorithm, based on illumination conditions that existed at a place and time of capturing the image that said pixels are associated with.

7. The method of claim 1, further comprising a step of generating a three-dimensional video stream from multiple groups of images, wherein all images that belong to a group from among the groups of images, were captured essentially simultaneously.

8. The method of claim 6, wherein the method further comprises a step of carrying out a matching process between images that belong to a specific group of images, by relying on information derived from images that belong to a group of images that were captured prior to the time at which the specific group of images was captured.

9. An electronic apparatus for generating a three dimensional image and comprising:
at least two capturing devices configured to focus on a target and to capture essentially simultaneously images thereof;
one or more processors configured to:
calculate or be provided with information on spatial deviations that exist between the at least two image capturing devices and to determine therefrom a correction function operative to correct location of pixels that belong to said images, thereby to retrieve their true locations within an undistorted image derived from an image that will be taken by the respective image capturing device;
retrieve two or more streams of pixels, each associated with an image captured by a respective one of the at least two image capturing devices;
apply the respective correction function onto received pixels from among the two or more streams of pixels;
store in a memory means data associated with pixels of the two or more streams of pixels;
invoke a stereo matching algorithm for processing data retrieved from the memory means; and
generate a three-dimensional image based on the results obtained from the stereo matching algorithm; and
a memory means configured to store data associated with only a substantially reduced number of pixels from among the pixels that belong to the two or more streams of pixels associated with the captured images.

10. The electronic apparatus of claim 9, wherein said memory means is capable of storing data associated with only from about 5% to about 25% of the number of pixels that belong to each of the two or more streams of pixels associated with the captured image.

11. The electronic apparatus of claim 9, wherein said memory means is capable of storing data associated with only 10% or less of the amount of pixels that belong to each of the two or more streams of pixels associated with the captured image.

12. The electronic apparatus of claim 9, further comprising an illuminator configured to illuminate a target whose images are being captured by the at least two image capturing devices at a time when said images are being captured.

13. The electronic apparatus of claim 9, wherein at least one of the image capturing devices is operative at the near Infra-Red (“NIR”) wavelength range.
